(19) United States
(12) Patent Application Publication
(10) Pub. No.: US 2017/0256957 A1
(43) Pub. Date: Sep. 7, 2017

(54) HYBRID POWER DELIVERY WITH IMPROVED POWER CONTROL

(71) Applicant: G4 Synergetics, Inc., East Setauket, NY (US)

(72) Inventors: Edward Buiel, Apison, TN (US); Joseph Michael, Gainsville, FL (US); Vlad Vichnyakov, Alachua, FL (US)

(21) Appl. No.: 15/446,397

(22) Filed: Mar. 1, 2017

Related U.S. Application Data
(60) Provisional application No. 62/303,994, filed on Mar. 4, 2016.

(51) Int. Cl. H02J 5/00; H02J 7/00; H02M 3/04; H02M 7/04; H02M 7/44

(52) U.S. Cl. CPC H02J 5/00; H02M 7/04; H02M 7/44; H02M 3/04; H02J 7/0068

(57) ABSTRACT

Disclosed herein are systems, devices, and methods for a hybrid power delivery system with improved energy storage system power control. The hybrid power delivery system may comprise a generator coupled to a variable frequency drive, in which a first power converter converts a first AC power from the generator to a DC power at the DC bus coupled to the first power converter. The DC bus is coupled to a second power converter, which converts the DC power to a second AC power. Also coupled to the DC bus is a power controller, which is also coupled to an energy storage system. The power controller is configured to regulate power flow between the energy storage system and the DC bus. The power controller may comprise at least one of a switch, a chopper circuit, a contactor, a silicon controlled rectifier, and/or a DC-to-DC converter.

### CROSS-REFERENCE TO RELATED APPLICATION

This application claims priority to U.S. Provisional Patent Application No. 62/303,994, filed Mar. 4, 2016, the content of which is hereby incorporated by reference herein in its entirety.

### BACKGROUNDS

Hybrid power delivery systems allow the use of both batteries and generators to manage power. For example, typical hybrid power systems for automobiles comprise both an internal combustion engine and an electric engine powered by batteries. By using battery and generator power, the automobile can conserve gasoline compared to automobiles that use only a conventional internal combustion engine. Some series-hybrid power delivery systems involve the direct connection of a battery and a generator to the same direct current (DC) bus. However, in this configuration, the battery is almost always supplying power, resulting in a high number of cycles and unpredictable load patterns. In such systems, the amount of power supplied by the battery may be controlled by the difference in impedance between the battery and the generator. This configuration leads to almost continuous use of the battery, rapid charge and discharge cycles, and high battery temperatures.

### SUMMARY

Disclosed herein are systems, devices, and methods for a hybrid power delivery system with the ability to control the amount of power provided to the hybrid power delivery system by the energy storage system. In particular, a power controller may be provided between an energy storage system and a DC bus of a drive system to regulate the power flow from the energy storage system to the drive.

According to one aspect, a hybrid power delivery system comprises a generator configured to generate a first AC power and a variable frequency drive coupled to the generator through a first power convertor. The first power converter is configured to convert the first alternating current (AC) power from the generator to DC power at a DC voltage. The variable frequency drive further comprises a DC bus at the DC voltage which is coupled to the first power convertor, and a second power converter, coupled to the DC bus, the second power converter configured to covert DC power at the DC voltage to a second AC power, which may be used to power a motor. A power controller may be coupled to the DC bus and coupled to an energy storage system, wherein the power controller is configured to regulate power flow between an energy storage system and the DC bus.

In certain implementations, the power controller may comprise at least one of a switch, a chopper circuit, a contactor, a silicon controlled rectifier, and/or a DC-to-DC converter. In certain implementations, a diode may be electrically coupled between the energy storage system and the DC bus. The diode may be coupled to the energy storage system and the DC bus in parallel with the power controller. In certain implementations, the diode may be configured to allow power to flow to the energy storage system from the DC bus, which may allow excess power on the DC bus to charge the battery, for example, during regenerative breaking. In certain implementations, the energy storage system may be a lead-acid battery, nickel-metal-hydride battery, a lithium ion battery, a lithium polymer battery, a bipolar battery, a capacitor, or any combination of the above.

In certain implementations, the first AC power and the second AC power may have common amplitudes and/or frequencies. In other implementations, the first and second AC powers may have different amplitudes and/or frequencies. For example, in some implementations, the generator may output an AC power at a certain voltage level and frequency, and the variable drive system may output AC power at the same voltage level and frequency. In other implementations, the variable drive system may output AC power at a different voltage level and/or frequency as the generator. For instance, the variable drive system may vary the amplitude and/or frequency of the output power to match a power required by a load being driven by the hybrid power system. In some implementations, the load may be a motor, and the speed and power desired for the motor may be used to control the voltage level and frequency of the second AC power.

In certain implementations, the hybrid power delivery system may further comprise processing circuitry. The processing circuitry may be configured to receive inputs from any of the components of the hybrid power system, including, but not limited to, the generator, the energy storage system, the power controller, and the DC bus. The processing circuitry may regulate the power delivered by the energy storage system. For example, the processing circuitry may adjust an output voltage and/or impedance of the power controller to regulate the power flow provided by the energy storage system. In certain implementations, the processing circuitry may regulate the power delivered by the energy storage system based on the aforementioned inputs. In certain implementations, the output voltage of the power controller may be controlled by regulating at least one switching frequency associated with at least one switch of the power controller.

According to one aspect, the processing circuitry may detect power supplied to the DC bus by the energy storage system, and determine that power supplied by the energy storage system to the DC bus exceeds a threshold power limit and in response, may reduce the power delivered by the energy storage system to the DC bus from a first voltage level to a second voltage level. For instance, the processing circuitry may detect how much power is supplied to the system by the energy storage system (for example by detecting a voltage and a current level supplied by the energy storage system) and compare the power supplied by the battery to a predetermined threshold power level. If the processing circuitry determines that the energy storage system power output is higher than the threshold power level, the processing circuitry may reduce an output voltage of the power controller from a first voltage level to a second voltage level.

In certain implementations, in response to determining that the power supplied by the energy storage system exceeds the threshold power level the processing circuitry may increase the power output of the generator from a first generator power level to a second generator power level. It will be understood by those of skill in the art that, although the systems and methods are described herein with respect to a single generator and a single energy storage system, any number of power sources and power source types may be combined and regulated using power controller(s), as described herein.

In certain implementations, the processing circuitry may detect operating level inputs from at least one of the generator, the DC bus, the power controller, and the energy storage system using processing circuitry and determine the threshold power level using the operating level inputs. The operating level inputs from the energy storage system may comprise at least one of a state of charge of the energy storage system, a state of health of the energy storage system, and/or a temperature of the energy storage system. In certain implementations, the operating level inputs from the generator may comprise at least one of a voltage of the generator and/or a frequency of power generated by the generator.

According to one aspect, power may be regulated and delivered by using the processing circuitry to detect how much power is supplied to a DC bus by a generator, and in response to determining that the power supplied to the DC bus by the generator exceeds a threshold power level, the processing circuitry may increase an output voltage of the power controller from a first voltage level to a second voltage level.

In certain implementations, regulating and delivering power include reducing the power output of the generator from a first generator power level to a second generator power level in response to determining that the power supplied to the DC bus by the generator exceeds the threshold power level.

In certain implementations, regulating and delivering power include determining that the state of charge of the energy storage system is less than a second threshold power level and, in response, reducing the output voltage of the power controller from a third voltage to a fourth voltage. The purpose of this second threshold power level may be to ensure that the state of charge of the energy storage system is maintained above a certain level, potentially acting as a safety measure to ensure the longevity of the energy storage system.

Variations and modifications will occur to those of skill in the art after reviewing this disclosure. The disclosed features may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented.

### BRIEF DESCRIPTION OF THE DRAWINGS

The foregoing and other objects and advantages will be apparent upon consideration of the following detailed description, taken in conjunction with the accompanying drawings, in which like reference characters refer to like parts throughout, and in which:

FIG. 1. shows a schematic view of an illustrative hybrid power delivery system;

FIG. 2 shows a schematic view of an illustrative hybrid power delivery system;

FIG. 3 shows a schematic view of an illustrative power controller;

FIG. 4 shows a schematic view of an illustrative hybrid power delivery system;

FIG. 5 shows a schematic view of an illustrative hybrid power delivery system;

FIG. 6 shows a schematic view of an illustrative hybrid power delivery system;

FIG. 7 shows a schematic view of an illustrative hybrid power delivery system;

FIG. 8 shows an illustrative flowchart for delivering power in a hybrid power delivery system; and

FIG. 9 shows an illustrative flowchart for delivering power in a hybrid power delivery system.

### DETAILED DESCRIPTION

To provide an overall understanding of the systems, devices, and methods described herein, certain illustrative embodiments will be described. Although the embodiments and features described herein are specifically described for use in connection with hybrid power delivery systems, it will be understood that the systems, devices, and methods described herein can be adapted and modified for any suitable power delivery application and that such other additions and modifications will not depart from the scope hereof.

As discussed above, typical series-hybrid power delivery systems involve the direct connection of a energy storage system and a generator to the same DC bus. However, in this configuration, the battery experiences frequent discharges, and the amount of power supplied by the battery depends only on the difference in impedance between the battery and the generator. Because the battery is directly connected to the DC bus, the battery is frequently and rapidly charged and discharged, resulting in high battery temperatures. This, in turn, results in inefficiencies, such as using fuel to charge the battery, and energy loss, due to resistance in the battery, in the series-hybrid power delivery system.

The hybrid power delivery systems disclosed herein utilize a power controller to regulate the amount of power supplied by the energy storage system to the hybrid power delivery system. By including the power controller, power may be drawn from the energy storage system on an as needed basis. Furthermore, because the state of charge of the energy storage system may be maintained at a high level, the system is less likely to burn fuel to charge the energy storage system. Therefore, the hybrid power delivery system benefits from relatively lower inefficiencies and energy loss, which leads to longer energy storage system lifespan and less fuel consumption.

In some embodiments, the hybrid power delivery system may utilize a diode coupled between a DC bus and the energy storage system. This diode may allow power to flow to the energy storage system from the DC bus, ensuring that excess power on the DC bus due to, for example, regenerative braking, can flow to the energy storage system and recharge the energy storage system. This ensures that excess energy in the hybrid power delivery system is used to charge the energy storage system, again helping to minimize energy loss in the system, and leading to less fuel consumption when compared to other series-hybrid power delivery systems.

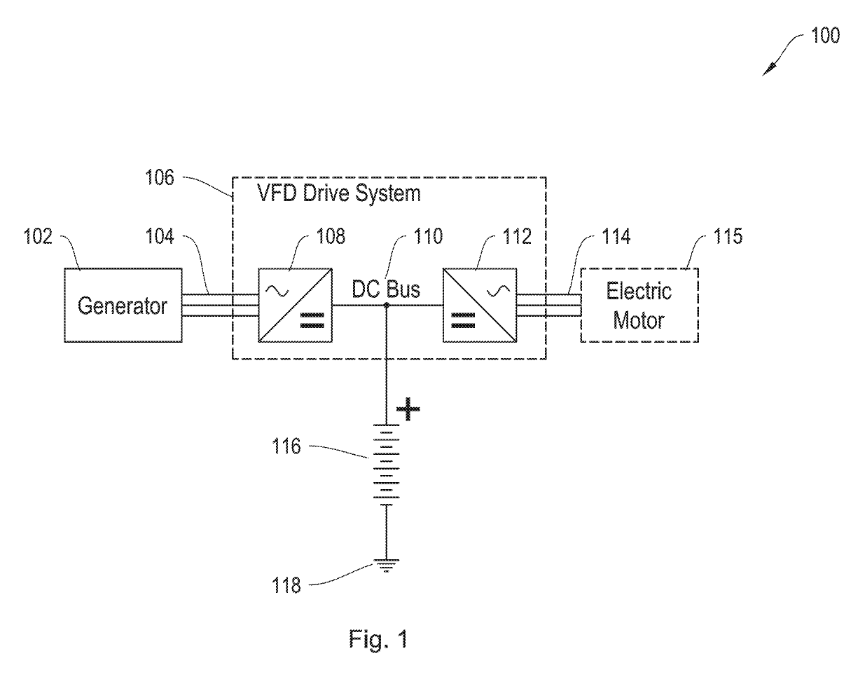

FIG. 1 shows a schematic view of an illustrative hybrid power delivery system 100 according to certain embodiments. The hybrid power delivery system 100 includes a generator 102, a first AC power 104, a variable frequency drive 106, a second AC power 114, an electric motor 115, and a battery 116. The variable frequency drive 106 includes a first power converter 108, a DC bus 110, and a second power converter 112. The generator 102 outputs a first AC power 104, which the first power converter 108 converts to DC power at a DC voltage. The DC bus 110 is at the DC voltage, and the second power converter 112 converts the DC voltage to the second AC power 114 for use by the electric motor 115. DC bus 110 of variable frequency drive 106 is coupled to battery 116, which is in turn coupled to ground 118.

In some embodiments, the generator 102 in FIG. 1 may supply the first AC power 104 to the variable frequency drive 106. The variable frequency drive 106 may be configured to the convert the first AC power 108 to the second AC power 112, for use in the electric motor 115. The variable frequency drive 106 may be configured in such as way that the power level of the second AC power 112 may be determined by the operating requirements of the electric motor 115. This system allows the battery 116 to supply power to the DC bus 110, in such as way that the battery 116 can increase the current and voltage on the DC bus 110 when compared to that supplied only by the generator. In this way, the battery 116 may decrease the amount of power the generator 102 needs to supply. Additionally, the battery 116 may act partially as a fail safe in the situation where the generator 102 can no longer supply power to the hybrid power delivery system 100.

In some embodiments, the generator 102 in FIG. 1 may supply the first AC power 104 to the variable frequency drive 106. However, the generator 102 may be replaced by another electric power supply, such as an energy storage system, wall outlet, flywheel, fuel cell, battery, capacitor, or other suitable electric power supply or combination thereof. Although the generator 102 is shown in FIG. 1 to output the first AC power 104, this arrangement is shown merely for illustrative purposes, and as would be understood by one of ordinary skill in the art, the generator 102 could output DC power as well. In some embodiments, the first power converter 108 may be a DC-to-DC converter, and in other embodiments, the generator 102 outputting a DC power may be directly connected to the DC bus 110. Furthermore, there may be multiple generators, where some may output AC power and some may output DC power.

The generator 102 may be set to output a constant AC or DC power, or output a variable amount of power. The generator 102 may be configured to receive user input, processing circuitry input, or inputs from various other parts of the hybrid power delivery system 100, or other various other external inputs. All or some of the inputs may be used to determine the power output of the generator 102, including amplitude and frequency of AC power generated.

The generator 102 may be any suitable generator for converting mechanical power into electrical energy, including, but not limited to, a homopolar generator, a magnetohydrodynamic generator, an induction generator, or any other suitable generator or combinations thereof. In some embodiments, the generator may be configured to connect to a mechanical mover. The generator may be permanently attached to this mechanical mover, or may be detachable. For example, the mechanical mover may be transported with the generator as a single unit. This mechanical mover may be an internal combustion engine, steam turbines, a diesel engine, gas turbine, or any other suitable mechanical mover or combination thereof. The mechanical mover may be powered by a fuel cell, energy storage system, nuclear reactor, or other suitable power source or combination thereof. In some embodiments, there may be two or more generators, of the same or different types.

The variable frequency drive 106 is shown in FIG. 1, according to some embodiments, to contain the first power convertor 108, the DC bus 110, and the second power convertor 112 outputting the second AC power 114. In some embodiments, the variable frequency drive 106 is used to convert the first AC power 104 to the second AC power 112 by way of the DC bus 110, allowing for the battery 116, which may output a DC power, to contribute power to the system by way of the DC bus 110. If the battery were to be connected to, for example, the first AC power 104, then the battery 116 may go through positive charge and discharge cycles, and the net power contribution to the system by the battery 116 may be zero. As would be understood by one of ordinary skill in the art, other configurations of the variable frequency drive 106 may be contemplated. For example, the variable frequency drive 106 may be configured to accept DC power as an input, and the first power convertor 108 may be a DC-to-DC convertor, or there may be no first power convertor 108. For another example, the second power convertor 112 may output a DC power, thus configuring the variable frequency drive 106 to output DC power. Furthermore, while there is one variable frequency drive show in FIG. 1, as would be understood by one of ordinary skill in the art, there may be more than one variable frequency drive coupled to a single generator, or multiple generators. Furthermore, the variable frequency drive 106 may be configured to contain additional power converters, or additional DC buses.

In some embodiments, the variable frequency drive 106 may be configured to output the second AC power 114. In some embodiments, the second AC power may be at the same amplitude and/or frequency as the first AC power 104. In other embodiments, the variable frequency drive 106 may be configured to output the second AC power 114 at a different amplitude and/or frequency than the first AC power 104.

The first power converter 108 is shown, according to some embodiments, to be an AC-to-DC converter. For example, the first power converter 108 may be a rectifier, switched-mode power supply, variable output AC-to-DC converter, or any other suitable AC-to-DC power converter. Furthermore, the first power converter 108 may be configured to convert DC power to DC power and may comprise, for example, a liner regulator, voltage regulator, a switched-mode DC-to-DC converter, a buck converter, a magnetic DC-to-DC converter, a switched capacitor convertor, or any other suitable DC-to-DC power converter of combination thereof. The first power converter 108 may be configured to convert to a single DC voltage, a range of DC voltages as a function of the first AC power 104, or variable DC voltages for the same first AC power 104. The second power converter 112 is illustratively shown to be a DC-to-AC converter, for example, second power converter may be an inverter or any other suitable AC-to-DC power converter or combination thereof. Furthermore, the second power converter 112 may be configured to convert DC power to DC power, and may be any of the illustrative DC-to-DC converters as described above with respect to the first power converter 108.

The variable frequency drive 106 may be coupled at the second power converter 112, for example, to the electric motor 115. The electric motor 115 may be a traction motor, switched reluctance motor, brushless DC or AC motor, permanent magnet DC motor, brushed DC motor, induction motor, synchronous motor, electrically excited DC motor, repulsion motor, or any other suitable electric motor. While FIG. 1 shows the electric motor 115 as the output load, it would be understood by one of ordinary skill in the art that the variable frequency drive may be coupled to an energy storage system, a power grid, an electronic device, or other application that requires electrical power.

The battery 116 is used as an illustrative example of an energy storage system that may be coupled to the DC bus 110. The battery 116 may be a capacitor, electric double-layer capacitor, flywheel, battery, rechargeable battery, traction battery, or other suitable energy storage device or combinations thereof. The energy storage system may be configured to release energy, and also to recharge when supplied excess energy from the hybrid power delivery system. The battery 116 may be configured to accept excess charge from the DC bus, and may also be configured to accept charge by way of different circuits and external energy sources. The battery may be permanent or replaceable.

The hybrid power delivery system 100 may be used as a power delivery system in cars, trucks, automobiles, buses, trains, locomotives, boats, submarines, planes, jets, helicopters, and other transportation systems. In some embodiments, the hybrid power delivery system may be used in a truck, where the generator may be coupled to an internal combustion engine and the variable frequency drive outputs to a traction motor. This system will allow for less fuel usage as compared to those systems that do not incorporate an energy storage system such as battery 116. The hybrid power delivery system 100 may be used in coal plants, back-up generators, camping generators, electrical device operation, or in other applications that require electrical power.

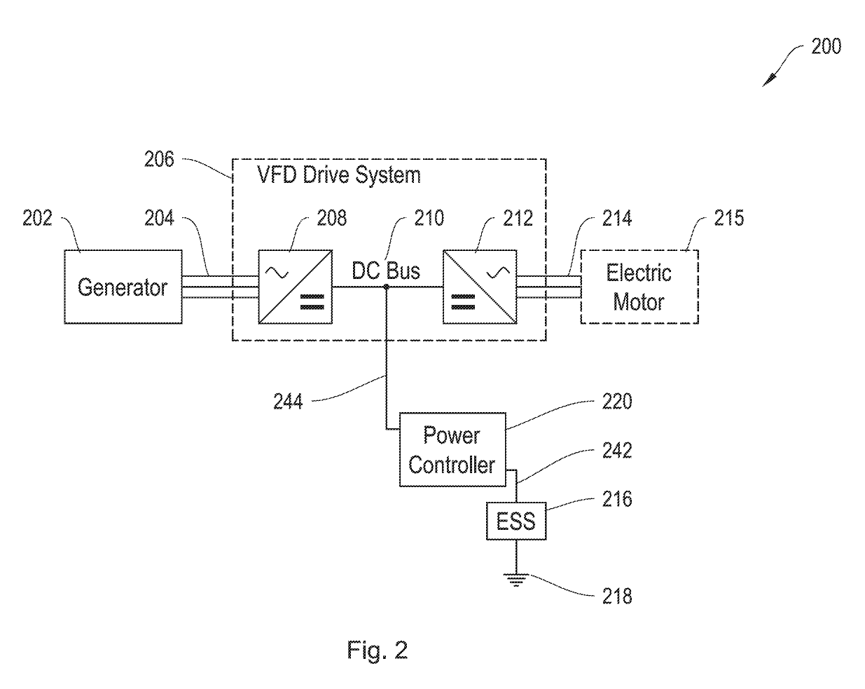

FIG. 2 shows a schematic view of an illustrative hybrid power delivery system 200 featuring a power controller 220, according to some embodiments. The hybrid power delivery system 200 comprises a generator 202, a first AC power 204, a variable frequency drive 206, a second AC power 214, an electric motor 215, the power controller 220, a power controller input 242, a power controller output 244, and an energy storage system 216. The variable frequency drive 206 comprises a first power converter 208, a DC bus 210, and a second power converter 212. The generator 202 outputs a first AC power 204, which is electrically coupled to the first power converter 208 of the variable frequency drive 206. The DC bus 210 is electrically coupled to the output of the first power converter 208, and is also coupled to the second power converter 212, which outputs the second AC power 214 to the electric motor 215. The energy storage system 216 is electrically coupled to ground 218 and to the power controller 220 by way of the power controller input 242, which is coupled to the DC bus 210 through the power controller output 244.

The power controller 220 allows for the regulation of current and power flow from the energy storage system 216 to the DC bus 210. As discussed above, this added ability to control power flow allows for a more efficient system and for the less fuel usage. Furthermore, the power controller 220 may allow for a graded power supply, introducing heightened levels of customization in how energy from the energy storage system 216, which may be substantially similar to the battery 116 of FIG. 1, is used in the hybrid power delivery system 200. In some embodiments, the power controller 220 may be configured to receive inputs from, for example, the electric motor 215, the generator 202 or the energy storage system 216, and determine the output power from the energy storage system 216 to the DC bus 210 in response to these inputs, allowing for further customization of the system and may contribute to overall system health and heightened efficiency. This ability may allow for longer energy storage system lifespan, and may prevent energy storage system problems, for example, high temperatures and rapid changes between battery charging and discharging.

In some embodiments, the power controller 220 may comprise power conversion circuitry. This power conversion circuitry may include a DC-to-DC converter, a switch, a chopper circuit, a silicon controlled rectifier, a rectifier, a contactor, a diode, or any other suitable power regulation circuitry or combination thereof. These circuit elements may be configured to allow power to flow from the energy storage system 216 to the DC bus 210. Furthermore, the power controller 220 may be configured such that the power controller output 244 may be in discrete levels, or in a continuous range of DC power outputs. According to some embodiments, the power controller 220 is shown as a discrete element, however, it may be integrated into the generator, energy storage system, or other suitable element of the hybrid power delivery system 200 or external element. While, according to some embodiments, FIG. 2 shows a single power controller, as would be understood by one of ordinary skill in the art, other configurations may be contemplated. For example, there may be one or more power controllers coupled between the energy storage system 216 and the DC bus 210, either in series or in parallel, and may involve the same or different power conversion circuitry. Further, as there may be multiple energy storage systems present in the system, all or some of these energy storage systems may connect to the power controller 220, or all or some may connect to the DC bus 210 by way of different power controllers.

While the power controller 220 and its power conversion circuitry are described above as controlling power flow from the energy storage system 216 to the DC bus 210, in some embodiments, the power controller 220 may contain power conversion circuitry that is configured to control power flow both from the energy storage system 216 to the DC bus 210, as well as from the DC bus 210 to the energy storage system 216. In addition to those features described above in relation to controlling power flow from the energy storage system 216 to the DC bus 210, the power controller 220 may also control power flow from the DC bus 210 to the energy storage system 216. In this way, the power controller 220 can control power flow in the case of certain events occurring at the DC bus 210, such as a regeneration event, a connection/disconnection in the system, a power surge, a power spike, or any other power event occurring at the DC bus 210. The power controller 220 may provide charge to the energy storage system 216 when there is excess power on the DC bus 210. The power controller 220 may prevent/regulate charge from flowing to the energy storage system 216 from the DC bus 210 if that charge would overload the energy storage system 216, if the energy storage system 216 is already fully charged, if the energy storage system 216 is operating at too high of a temperature, or may prevent/regulate charge flowing to the energy storage system 216 from the DC bus 210 for any other suitable reason. The power controller 220 controlling power in a bidirectional manner may allow not only for efficiency in the system, but may also allow for long-term health of the energy storage system 216.

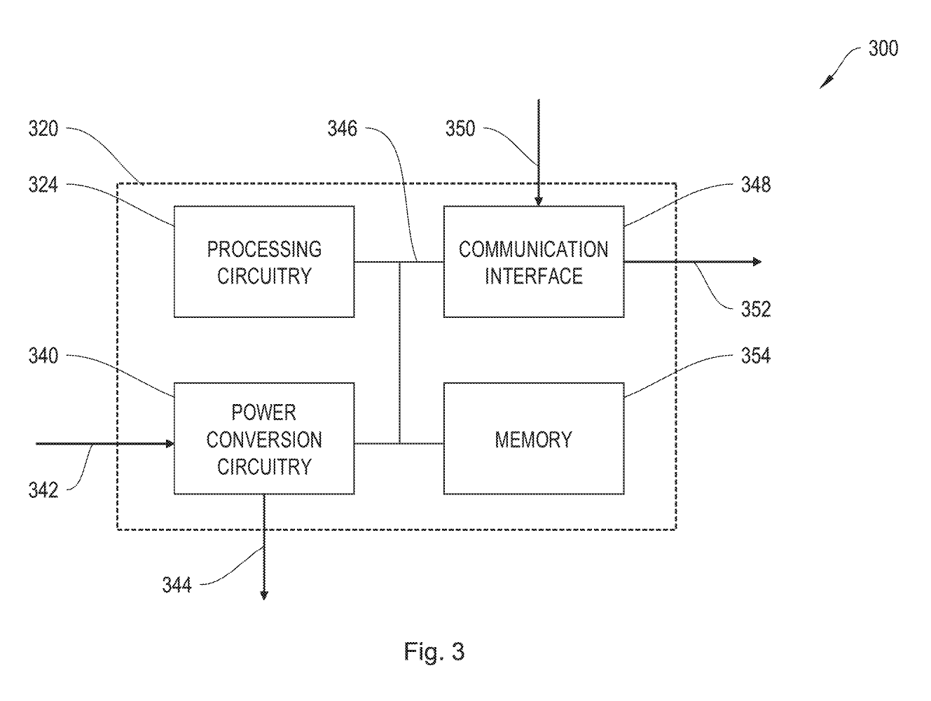

The power controller 220 may comprise additional circuitry and elements. In addition to power conversion circuitry, which may be bidirectional, the power controller 220 may include processing circuitry, a communication interface, memory, user displays, storage, and other circuitry and processing elements or combinations thereof. FIG. 3 shows a schematic view of an illustrative power controller 300, according to some embodiments. The power controller 320 comprises power conversion circuitry 340, which may be substantially similar to the power conversion circuitry as discussed in reference to the power controller 220 in FIG. 2, processing circuitry 324, a communication interface 348, and memory 354. The power conversion circuitry 340 may be configured to receive the power controller input 342 and output the power controller output 344. The communication interface 348 may be configured to receive the communication inputs 350, and output the communication outputs 352. The processing circuitry 324, power conversion circuitry 340, communication interface 348, and memory 354 may all be coupled by way of connections 346.

In some embodiments, the power controller 320 may allow for storage and receipt of various system inputs, and may allow for processing of these inputs to determine various system outputs. In some embodiments, the inputs may come from anywhere in the hybrid power delivery system and may be processed in algorithms or functions, which determine appropriate outputs. For example, the power controller output 344 may be controlled by the processing circuitry, and the use of these algorithms may control when the energy storage system delivers power to the hybrid power delivery system, such that the energy storage system may be used on an as needed basis. As discussed above, this added customization may allow for a more efficient hybrid power delivery system.

The communication interface 348 may comprise any suitable hardware for receiving and transmitting signals using communication inputs 350 from various elements of the hybrid power delivery system 200 of FIG. 2. For example, communication inputs may comprise generator data, such as voltage, frequency and operating point of the generator, energy storage system data, such as state of charge, state of health, and temperature of the energy storage system, power required by, for example, a traction motor or other output load, DC bus voltage, user inputs, power controller operating data, first power converter operating data, second power converter operating data, fuel tank level, or any other suitable input or combination thereof. Furthermore, the communication interface 348 may be configured to output communication outputs 352 to various elements of the hybrid power delivery system 200 of FIG. 2 and other external elements. These outputs may include generator controls, energy storage system controls, mechanical mover controls, user interface display controls, and instructions to power conversion circuitry, which may also be sent by way of the connections 346.

The memory 354 may be configured to store data over time from the power conversion circuitry 340, the processing circuitry 324, and the communication interface 348. For example, it may store information about past and current energy storage system temperature and use, generator operation over time, past and current power controller output, which may be substantially similar to the power controller output 244 of FIG. 2. The memory 354 may comprise dynamic random access-memory, static access memory, hard drives, floppy disks, magnetic storage devices, flash memory, or other suitable memory storage devices or combinations thereof.

The memory 354 may be configured to store algorithms or functions for use in determining the communication outputs 352 and the power controller outputs 344. These algorithms or functions may be used to analyze some or all inputs, that is, power controller inputs or communication inputs, and stored data in the memory 354, and using said algorithms or functions and said inputs to compute new power controller outputs 344 and/or communication outputs 352.

The processing circuitry 324 may comprise any suitable hardware capable of being configured to process, communicate, and control inputs and outputs of power controller 320. For example, the processing circuitry may be one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the processing circuitry may be configured to access memory 354 and determine an appropriate stored algorithm or function based on the current inputs, and then use inputs from the communication interface 348, such as energy storage system temperature, and stored data in the memory 354, such as recent history of energy storage system temperature, to determine new communication outputs 352, such as increasing the generator output voltage, and new power controller outputs, such as lowering the voltage output by the power conversion circuitry 340. As would be understood by one of ordinary skill in the art, other inputs and storage data from the memory 354 may be used by the processing circuitry, and may be used in a variety of algorithms or functions. Furthermore, it would be understood by one of ordinary skill in the art that processing circuitry may be configured to use a variety of algorithms or functions to determine other outputs not previously described.

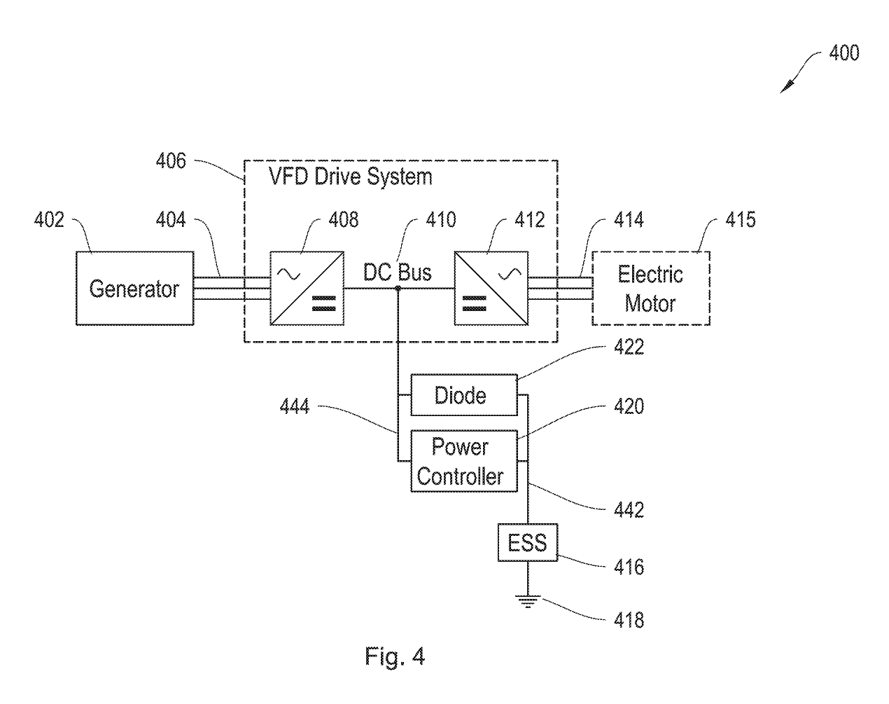

FIG. 4 shows a schematic view of an illustrative hybrid power delivery system 400 featuring a power controller 420 and a diode 422, according to some embodiments. The hybrid power delivery system 400 comprises a generator 402, a first AC power 404, a variable frequency drive 406, a second AC power 414, an electric motor 415, the power controller 420, a power controller input 442, a power controller output 444, the diode 422, and an energy storage system 416. The variable frequency drive 406 comprises a first power converter 408, a DC bus 410, and a second power converter 412. The generator 402 outputs the first AC power 404, which is electrically coupled to the first power converter 408 of the variable frequency drive 406. The DC bus 410 is electrically coupled to the output of the first power converter 408, and also coupled to the second power converter 412, which outputs the second AC power 414 to the electric motor 415. The energy storage system 416 is electrically coupled to ground 418 and to the power controller 420 by way of the power controller input 442, which is coupled to the DC bus 410 through the power controller output 444. The energy storage system 416 is electrically coupled to the diode 422, which is then subsequently electrically coupled to the DC bus 410. In some embodiments, the diode 422 may be configured to allow power to flow to the energy storage system 416 during, for example, during regenerative breaking when the hybrid power delivery system 400 is used in automobiles. If the diode 422 is configured to allow power to flow to the energy storage system 416, then power can flow to the battery any time there is excess power on the DC bus 410, independent of other components in the hybrid power delivery system 400, such as the power controller 420. The diode 422, therefore, may minimize or eliminate power loss during periods of excess power, allowing for the system to store the excess power, in the energy storage system 416, and reuse said excess power.

The diode 422 may be more than one diode and may be another suitable device contemplated by one of skill in the art that allows for unidirectional current flow. The diode 422, according to some embodiments, is shown to be coupled in parallel to the power controller 422, and coupled to the same DC bus 410 as the power controller 422, and to the same energy storage system 416 as the power controller 422. As would be understood by one of ordinary skill in the art, and as discussed above, there may be more than one DC bus, and thus the diode 422 may be coupled to any suitable DC bus. Additionally, there may be more than one energy storage system in the hybrid power delivery system 400, and the diode 422 may be coupled to any suitable energy storage system. According to some embodiments, the diode 422 is shown as a single diode which is wholly separate from the power controller 420, however, as would be understood by one of ordinary skill in the art, other configurations may be contemplated, such as the integration of the diode 422 into the power controller 420 or other element of the hybrid power delivery system 400. Furthermore, the diode 422 may be configured to allow current to flow to the energy storage system 416. A diode in this configuration may allow for charging of the energy storage system 416 by, for example, regenerative breaking, excess power supplied by the generator 402, excess power supplied by a traction motor, or excess power supplied by an external charging mechanism.

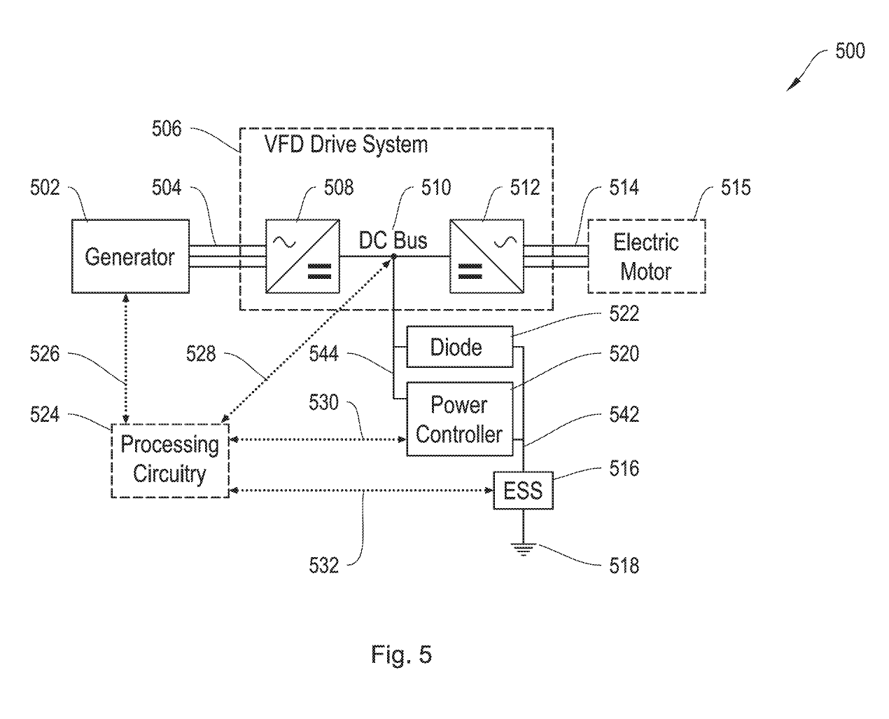

FIG. 5 shows a schematic view of an illustrative hybrid power delivery system 500 featuring a diode 522, a power controller 520, and processing circuitry 524, according to some embodiments. The hybrid power delivery system 500 comprises a generator 502, a first AC power 504, a variable frequency drive 506, a second AC power 514, an electric motor 515, the power controller 520, a power controller input 542, a power controller output 544, the diode 522, an energy storage system 516, and the processing circuitry 524. The variable frequency drive 506 comprises a first power converter 508, a DC bus 510, and a second power converter 512. The generator 502 outputs a first AC power 504, which is electrically coupled to the first power converter 508 of the variable frequency drive 506. The DC bus 510 is electrically coupled to the output of the first power converter 508, and also coupled to the second power converter 612, which outputs the second AC power 614. The energy storage system 516 is electrically coupled to ground 518 and to the power controller 520 by way of the power controller input 542, which is coupled to the DC bus 510 through the power controller output 544. The energy storage system 516 is also electrically coupled to the diode 522, which in turn is electrically coupled to the DC bus 510. The processing circuitry 524 is set to communicate with the generator 502 by way of a generator communication line 526, with the DC bus 510 by way of a DC bus communication line 528, with the power controller 520 by way of a power controller communication line 530, and with the energy storage system 516 by way of an energy storage system communication line 532.

In some embodiments, the diode 522 may be substantially similar to the diode 422 of FIG. 4. According to some embodiments, the processing circuitry 524 is shown to be a distinct element in the hybrid power delivery system 500, however, the processing circuitry 524 may be integrated into the power controller 520, and may be similar to the power controller 320 in FIG. 3. The use of the diode 522, the processing circuitry 524 with the communication lines 526, 528, 530, and 532, which may be substantially similar to the communication inputs 350 in FIG. 3, and the power controller 520 in the hybrid power delivery system 500 allows for the aggregate benefits of each component individual component, as described above. In the aggregate, this system may allow for regenerative breaking and customization of battery usage, all together achieving a system with little energy loss and better system health. In some embodiments, such as those in an automobile, this system can allow for less fuel usage, as well as allowing for a lower horsepower, and thus lighter, engine, as the excess energy needed may be supplied by the energy storage system 516.

According to some embodiments, the processing circuitry 524 is shown to be a distinct element in the hybrid power delivery system 500. As would be understood by one of ordinary skill in the art, the processing circuitry 524 may be integrated into the power controller 520, the generator 502, the energy storage system 516, or any other suitable element contemplated by one of ordinary skill in the art. The processing circuitry 524 may be, for example, a computer, a processor, a microprocessor, or a server. Furthermore, the processing circuitry 524 may be located in close proximity to the other elements in the system, onboard a portable system, or it may be stored at an external location. The communication lines 526, 528, 530, and 532 may be physical electrical connections, local area network connections, or wireless communications, or any other suitable form of long or short range communication of combinations thereof.

According to some embodiments, the processing circuitry 524 is shown to receive inputs by way of the communication lines 526, 528, 530, and 532, these inputs being substantially similar to the communication inputs 350 of FIG. 3. Furthermore, processing circuitry may send commands or outputs by way of the communication lines 526, 528, 530, and 532, these outputs being substantially similar to the communication outputs 352 of FIG. 3. The processing circuitry 524 may be configured to communication with additional sources, such as the first power controller 508, the second power controller 512, a user interface, an external data storage device, memory, a fuel tank, or any device to which the hybrid power delivery system 500 outputs power, as described in connection with the variable frequency drive 106 in FIG. 1 or any combination thereof. All communication lines 526, 528, 530, and 532 are illustratively shown to be a single communication line, however, as would be understood by one of ordinary skill in the art, two or more communication lines may also be used when receiving inputs or sending outputs to a single device.

The generator communication line 526 may be configured to communicate, for example, the first AC power 504, generator operating level, generator frequency, and/or generator health to the processing circuitry 524. Furthermore, the generator communication line 526 may be configured to change the first AC power 504 output by the generator 502, change the generator frequency, or output any other suitable command to the generator 502 of combination thereof. According to some embodiments, generator communication line is shown as a single communication line, however, for example, generator input and output lines may be distinct communication lines.

The energy storage system communication line 532 may be configured to input to the processing circuitry 524, for example, energy storage system health, temperature, state of charge, operating levels, charge or discharge rate, or any other suitable information concerning the energy storage system 532 or any combination thereof. Furthermore, the energy storage system communication line 532 may additionally be configured to output controls to change battery usage or control battery temperature.

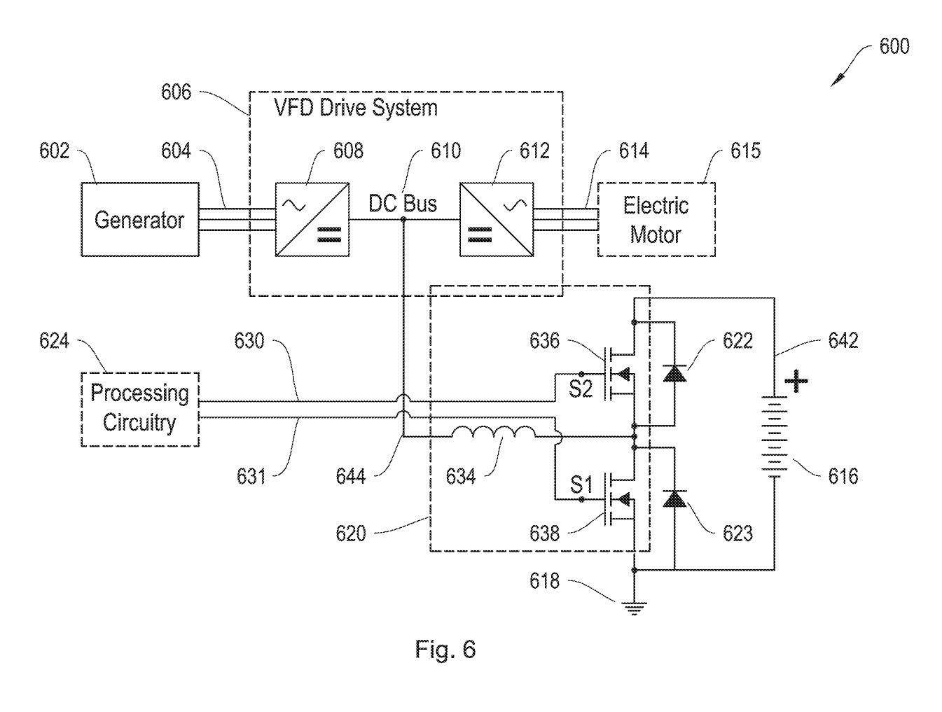

FIG. 6 shows a schematic view of an illustrative hybrid power delivery system 600 featuring illustrative power controller circuitry 620, a first diode 622, a second diode 623, an energy storage system 616, and processing circuitry 624, according to some embodiments. The hybrid power delivery system 600 comprises a generator 602, a first AC power 604, a variable frequency drive 606, a second AC power 614, an electric motor 615, the power controller 620, a power controller input 642, a power controller output 644, the first diode 622, the second diode 623, an energy storage system 616, and the processing circuitry 624. The variable frequency drive 506 comprises a first power converter 508, a DC bus 510, and a second power converter 512. Furthermore, the power controller 620 comprises an inductor 624, a first switch 636 which connects to processing circuitry 624 by way of first a communication line 630, and a second switch 638 which connects to the processing circuitry 624 by way of a second communication line 631. The generator 602 outputs the first AC power 604, which is electrically coupled to the first power converter 608 of the variable frequency drive 606. The DC bus 610 is electrically coupled to the output of the first power converter 608, and also coupled to the second power converter 612, which outputs the second AC power 614 to the electric motor 615. The energy storage system 616 is coupled to ground 618 and to the power controller 620 by way of the power controller input 642. More specifically, the energy storage system 616 is coupled to the first switch 636 and the second switch 638, both of which are coupled to the inductor 634, which in turn is electrically coupled to the DC bus 610. The diodes 622 and 623 are configured to allow power to flow to the energy storage system 616 from the DC bus 610.

The power controller 620 comprises illustrative circuitry. The power controller 620 is a single embodiment of the power controller 220 of FIG. 2, and may be another power controller device as detailed in the discussion of the power controller 220. In some embodiments, the power controller 620 may control the power supplied by the energy storage system 616 to the DC bus 610. It may control the power controller output 644 by alternating the switches 636 and 638 between configurations in which they allow power flow from the energy storage system 616, and configurations in which they do not allow power flow from the energy storage system 616. They may switch periodically, and furthermore, may switch with the same frequency or different frequencies. The first switching frequency of the first switch 636 may be controlled by the processing circuitry 624 by way of the first communication line 630. Likewise, the second switching frequency of the second switch 638 may be controlled by the processing circuitry 624 by way of the second communication line 631. This illustrative configuration allows for a graded power controller output 644 across a continuous range of voltage and power levels, allowing for increased customization of the energy storage system 616 usage. The processing circuitry 624 may be substantially similar to the processing circuitry 324 of FIG. 3, or to the processing circuitry 524 of FIG. 5.

The energy storage system 616 is shown in FIG. 6 to be a battery. The energy storage system 616 may be substantially similar to the energy storage system 116 of FIG. 1, and, as would be understood by one of ordinary skill in the art, other configuration may be contemplated, such as those presented in the discussion of the energy storage system 116.

For illustrative purposes, the communication lines 630 and 631 are shown as electrical connections. However, as would be understood by one of ordinary skill in the art, these communication lines may be, for example, wireless communications.

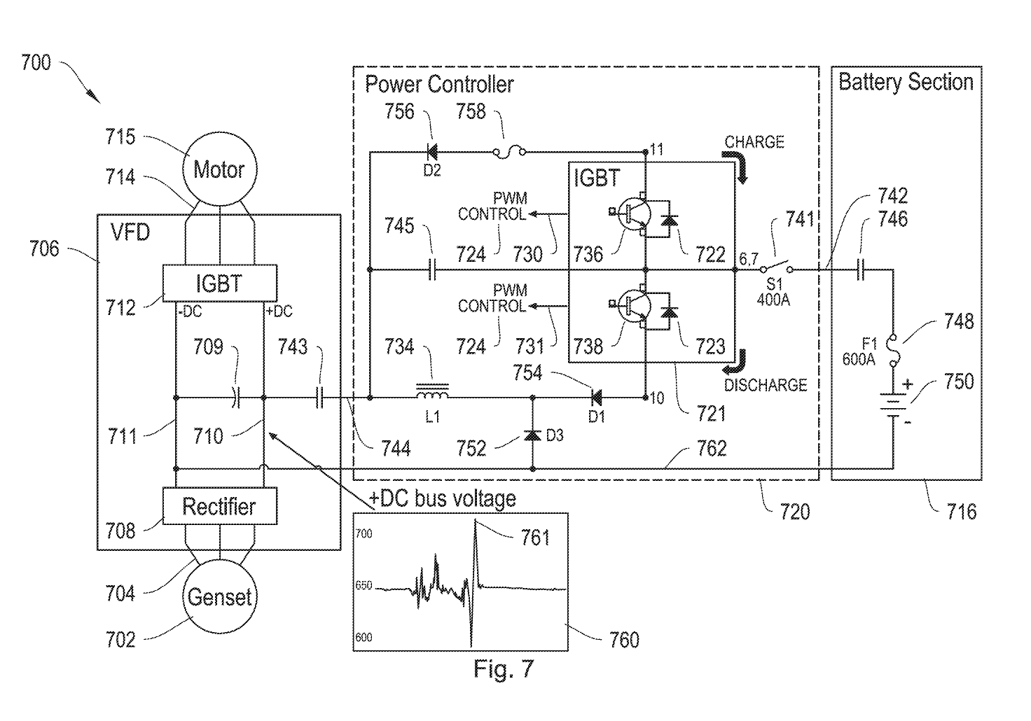

FIG. 7 shows a schematic view of an illustrative hybrid power delivery system 700 featuring illustrative power controller circuitry 720, an illustrative energy storage system 716, and an illustrative variable frequency drive 706, according to some embodiments. The hybrid power delivery system 700 comprises a genset 702, a genset output power 704, the illustrative variable frequency drive 706, a variable frequency drive output power 714, a motor 715, a VFD-PC connection 744, the illustrative power controller 720, a PC-ESS connection 742, the illustrative energy storage system 716, and a negative connection 762. The illustrative variable frequency drive 706 comprises a rectifier 708, a positive DC bus 710, a negative DC bus 711, a first insulated-gate bipolar transistor 712, a first VFD capacitor 709, and a second VFD capacitor 743. Furthermore, the illustrative power controller 720 comprises an inductor 734, a first diode 754, a second diode 756, a third diode 752, a power controller fuse 758, a power controller capacitor 745, a switch 741, and a second insulated-gate bipolar transistor 721. The second insulated-gate bipolar transistor 721 comprises a first IGBT diode 722, a second IGBT diode 723, a first transistor 736, a second transistor 738, a first communication line 730, and a second communication line 731. The first communication line 730 and second communication line 731 are both connected to a pulse width modulation control 724. Furthermore, the illustrative energy storage system 716 comprises an energy storage system capacitor 746, an energy storage system fuse 748, and a battery 750. The hybrid power delivery system 700 further comprises an illustrative positive DC bus voltage profile 760 comprising a power event 761.

The genset 702 outputs the genset output power 704, which is electrically coupled to the rectifier 708 of the illustrative variable frequency drive 706. The positive DC bus 710 and the negative DC bus 711 are electrically coupled to the output of the rectifier 708. Coupled between the positive DC bus 710 and negative DC bus 711 is the first VFD capacitor 709. The positive DC bus 710 and the negative DC bus 711 are both electrically coupled to the first insulated-gate bipolar transistor 712, which outputs the variable frequency drive output power 714 to the motor 715. The first insulated-gate bipolar transistor may also output power to the positive DC bus 710 and the negative DC bus 711. Positive DC bus 710 is coupled to second VFD capacitor 743, which is in turn coupled to illustrative power controller 720 by way of the VFD-PC connection 744. In turn, the VFD-PC connection 744 is coupled to the power controller capacitor 745, the second diode 756, and the inductor 734. The second diode 756 is connected to power controller fuse 758, and allows excess charge on the positive DC bus 710 to charge the illustrative energy storage system 716. Furthermore, the VFD-PC connection 744 is connected to inductor 734, which is in turn connected to first diode 754, which allows power to flow from the illustrative energy storage system 716 to provide power to the positive DC bus 710. The third diode 752 allows for unidirectional flow between the negative connection 762 and the inductor 752. The negative connection 762 connects the negative terminal of the battery 750 and the negative DC bus 711. The VFD-PC connection 744 is lastly connected to the power controller capacitor 745, which shares charge between the VFD-PC connection 744 and the second insulated-gate bipolar transistor 721. The second insulated-gate bipolar transistor 721 is electrically coupled between the power controller fuse 756, the power controller capacitor 745, a first diode 754. Power is input to the second insulated-gate bipolar transistor 721 from the power controller fuse 758 by way of the first transistor 736, which is connected in parallel with the IGBT diode 722. Power is output from the second insulated-gate bipolar transistor to the first diode by way of the second transistor 738, which is connected in parallel with the IGBT diode 723. Both the first transistor 736 and the second transistor 738 are connected to the pulse width modulation control 724 by way of the first communication line 730 and the second communication line 731 respectively. The pulse width modulation control 724 can receive electrical signals from the first transistor 736 and the second transistor 738, and can also delivery signals to the two transistors. The second insulated-gate bipolar transistor is further coupled to the switch 741. Switch 741 can control power flow between the illustrative energy storage system 716 and the second insulated-gate bipolar transistor 721 by way of the PC-ESS connection 742. The PC-ESS connection is coupled to the energy storage system capacitor 746, which in turn is connected to the second fuse 748. These two elements may control power flow to and from the battery 750. Lastly, the battery 750 is connected to the negative DC bus 711 by way of negative connection 762.

The illustrative power controller 720 used in the hybrid power delivery system 700 may be a bidirectional power controller, and as such may regulate power flow to and from the illustrative energy storage system 716. The illustrative power controller 720 is connected to the pulse width modulation control 724 by way of the second insulated-gate bipolar transistor 721, as discussed above. The pulse width modulation control 724 may be connected to processing circuitry or integrated into processing circuitry, wherein the processing circuitry may be substantially similar to the processing circuitry 624 of FIG. 6 or the processing circuitry 524 of FIG. 5. As discussed above, the processing circuitry may receive inputs, such as data from the genset 702, such as voltage, frequency and operating point of the genset 702, data from the illustrative energy storage system 716, such as state of charge, state of health, and temperature of the illustrative energy storage system 716, power required by, for example, the motor 715, the positive DC bus 711 voltage, user inputs, the illustrative power controller 720 operating data, the rectifier 708 operating data, the first insulated-gate bipolar transistor 712 operating data, fuel tank level, or any other suitable input or combination thereof. This processing circuitry may use these inputs to control the output of pulse width modulation control 724.

The pulse width modulation control 724 may control power flow to and from the illustrative energy storage system 716. For example, the pulse width modulation control 724 may transmit a control signal that indicates a varying duty cycle for one or both of transistor 736 or transistor 738. As discussed, the second insulated-gate bipolar transistor 721 contained in the illustrative power controller 720 may allow power to flow to the illustrative energy storage system 716 by way of the input from the power controller fuse 758. The first communication line 730 may transmit signals from the pulse width modulation control 724 to the first transistor 736, either allowing power to flow to the illustrative energy storage system 716, or blocking the power flow. Similarly, the second communication line 731 may transmit signals from the pulse width modulation control 724 to the second transistor 738, which may allow power to flow from the illustrative energy storage system 716 to the positive DC bus 710. While a single pulse width modulation control is shown in the hybrid power delivery system 700, the first communication line 730 may be connected to a first pulse width modulation control, and the second communication line 731 may be connected to a second pulse width modulation control, which may in turn be connected to the same or separate processing circuitries. By controlling bidirectional power flow between the illustrative energy storage system 716 and the positive DC bus 710, the illustrative power controller 720 may minimize rapid charge and discharge events, may maintain charge in the illustrative energy storage system 716 for use when needed, and may increase the life of the illustrative energy storage system 716.

Additional power regulation elements are provided in addition to the first transistor 736 and the second transistor 738 in the hybrid power delivery system 700. For example, the power controller fuse 758 may be designed to terminate power flow in the event that the power flow from the positive DC bus reaches a threshold level. The switch 741 may be similarly designed to terminate power flow in the event that the power flow from the positive DC bus reaches the same, or different, threshold level. Alternatively, the switch 741 may be coupled to processing circuitry, which may control whether the switch allows power to flow to or from the illustrative energy storage system 716. Other power regulation elements may include the power controller capacitor 745, the energy storage system capacitor 746, the energy storage system fuse 748, the inductor 734, and/or the first VFD capacitor 743. It would be understood by one of ordinary skill in the art that these power regulation elements are merely illustrative, and that other elements in the hybrid power delivery system 700 may act as power regulation elements, and further power regulation elements may be included in the hybrid power delivery system 700.

The illustrative energy storage system 716, as discussed above, has additional power regulation elements, namely, the energy storage system capacitor 746 and the energy storage system fuse 748. The illustrative energy storage system 716 may be similar to the energy storage system 116 of FIG. 1. It would be understood by one of ordinary skill in the art that the illustrative energy storage system 716 may include additional elements, such as additional capacitors, batteries, fuses, or any other suitable component or combination thereof. The battery 750 may be a lead-acid battery, nickel-metal-hydride battery, a lithium ion battery, a lithium polymer battery, or a bipolar battery. Furthermore, while for illustrative purposes, a single energy storage system is shown, it would be understood by one of ordinary skill in the art that multiple energy storage systems may be used.

The illustrative variable frequency drive 706 may be similar to the variable frequency drive 106 of FIG. 1. The illustrative variable frequency drive 706 may receive, at the rectifier 708, a genset output power 704 from the genset 702, which may be an AC power. The rectifier 708 may output a DC power at a DC voltage to the positive DC bus 710 and the negative DC bus 711. The first insulated-gate bipolar transistor 712 may be configured to regulate the variable frequency drive output power 714, which may be an AC power or DC power, which may depend on the required input for the motor 715. The motor 715 may additionally supply power back to the first insulated-gate bipolar transistor 712 for conversion to a DC power at a DC voltage to the positive DC bus 711 and the negative DC bus 711, for example, during a regeneration event. This power may in turn be used to charge the battery through the illustrative power controller 720, as described above. The first insulated-gate bipolar transistor may further be controlled by the processing circuitry discussed above.

The motor 715 may be any motor that is driven by electric power, and may be a traction motor, switched reluctance motor, brushless DC or AC motor, permanent magnet DC motor, brushed DC motor, induction motor, synchronous motor, electrically excited DC motor, repulsion motor, or any other suitable electric motor. While FIG. 7 shows the electric motor 715 as the output load, it would be understood by one of ordinary skill in the art that the variable frequency drive may be coupled to an energy storage system, a power grid, an electronic device, or other application that requires electrical power.

The genset 702 may be any suitable combination of an electric generator and a prime mover, and may be similar to the generator 102 of FIG. 1. As an illustrative example, the genset 702 may be the combination of an internal combustion engine and a homopolar generator, a magnetohydrodynamic generator, or an induction generator. As another illustrative example, the prime mover of the genset 702 may be a diesel engine. Furthermore, the genset 702 may use any type of fuel, such as diesel, gasoline, natural gas, propane, bio-diesel, hydrogen, or water.

The illustrative positive DC bus voltage profile 760 shows a sample voltage profile on the DC bus. The illustrative positive DC bus voltage profile 760 comprises the power event 761. The power event 761 may be any number of power events, such as a connection event, a disconnection event, a genset event, such as excess power supplied to the positive DC bus 710 by the genset 702, a power spike, or a regeneration event, such as when excess power is supplied to the positive DC bus 710 by the motor 715. The hybrid power delivery system 700, as described above, may be configured to regulate the power flow to the illustrative energy storage system 716 using the illustrative power controller 720 and using the power regulation elements described above. Further, the illustrative power controller 720 may be used regulate power supplied to the positive DC bus 710 by the illustrative energy storage system 716 in such events.

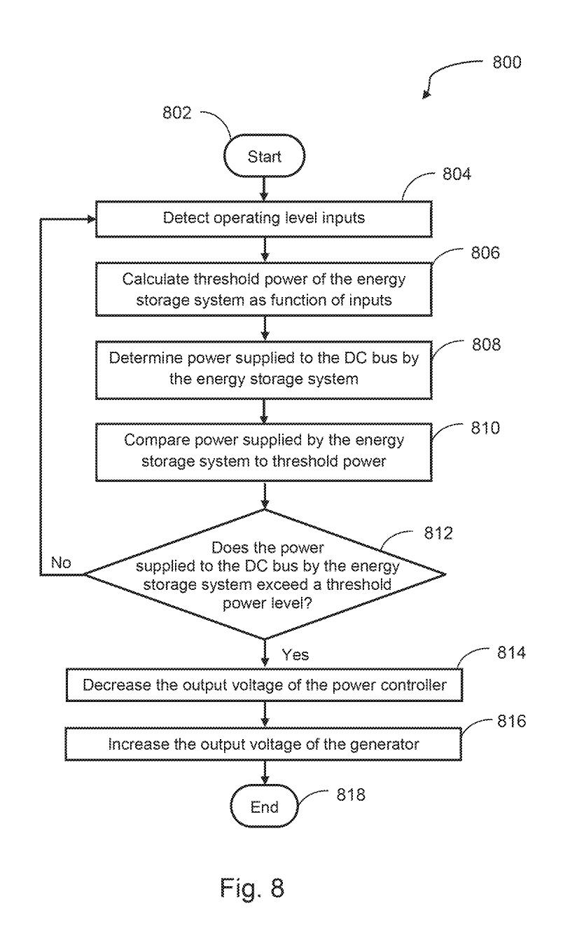

FIG. 8 shows an illustrative process for delivering power 800, according to some embodiments, in a hybrid power delivery system, such as those shown in FIGS. 1, 2, and 4-6. Process 800 includes detecting operating level inputs at 804, calculating a threshold power level of an energy storage system as a function of the inputs at 806, determining how much power is supplied to a DC bus by the energy storage system at 808, comparing power supplied by the energy storage system to the calculated threshold power level at 810, upon determining that the power supplied to the DC bus by the energy storage system exceeds a threshold power level at 812, decreasing the output voltage of a power controller at 814, and increasing the output voltage of a generator at 816. In some embodiments, the process 800 may be used to ensure that an energy storage system is used on an as needed basis. In some embodiments, the process 800 may be used by a hybrid power delivery system in an automobile, and the use of the process 800 may maintain battery charge for use, for example, when towing large loads, when driving up steep grades, when driving at high speeds, or when a generator can no longer supply enough power to the system. In particular, the process 800 may conserve battery charge when, for example, driving slowly on even grades or driving downhill. As such, this system may allow for a more reliable power delivery system.

At step 804, operating level inputs are determined. This may be performed by the processing circuitry 524 of FIG. 5 or the communication interface 348 of FIG. 3. Inputs may include, for example, generator data, such as voltage, frequency and operating point of the generator, energy storage system data, such as state of charge, state of health, and temperature of the energy storage system, power required by, for example, an electric motor or other output device, the DC bus voltage, user inputs, power controller operating data, first power converter operating data, second power converter operation data, fuel tank level, or any other suitable input contemplated by one of skill in the art or combination thereof from components of a hybrid power delivery system, which may be substantially similar to that in FIGS. 1,2, and 4-6, or other inputs external to the hybrid power delivery system. This data may be stored in a memory or storage device, such as the memory 354 of FIG. 3, analyzed by the component receiving the data, or communicated to further processing circuitry, such as the processing circuitry 324 of FIG. 3. Operating level inputs may also include historical input data, such as the input data discussed above which has been stored on a memory or storage system, such as the memory 354 of FIG. 3. Additionally, this data may be communicated to an external device configured to receive inputs from this system, or multiple systems, which may further store or analyze the data and create additional inputs which may be communicated to the processing circuitry.

At step 806, a threshold power level of an energy storage system, which may be substantially similar to the energy storage system 116 of FIG. 1, may be calculated as a function of the inputs determined at step 804. This may be done using the processing circuitry 324 of FIG. 3 or 524 of FIG. 5. This calculation may be done using an algorithm or function using some or all of the inputs. Additionally, this algorithm or function may be static and remain constant throughout the lifetime of the hybrid power delivery system, or may be updated at varying time intervals but either internal or external circuitry or additional algorithms based on input history and data stored in the memory. Furthermore, the threshold power level of the energy storage system may be a constant value and have no dependency on the inputs determined in 804.

At step 808 the power supplied to the DC bus, which may be substantially similar to the DC bus 210 of FIG. 2, by the energy storage system may be determined by, for example, the processing circuitry 524 of FIG. 5 or the communication interface 348 of FIG. 3. Illustrative examples of hybrid power delivery systems, FIGS. 1, 2, and 4-6, were presented, however, other configurations of the system may be contemplated. For example, the step 808 may include determining the power supplied to the DC bus by one or more energy storage systems, or may include determining power supplied to one of more DC buses of one or more variable frequency drives, which may be substantially similar to variable frequency drive 106 of FIG. 1.

At step 810, the threshold power level determined at step 806 may be compared to the power supplied by the energy storage system as determined at step 808. At step 812, if it is determined that the power supplied by the energy storage system determined at step 808 is less than or equal to the threshold power level, than the process may begin again, after some time period, at step 804, and the process 800 may then be repeated. However, at step 812, if it is determined that the power supplied by the energy storage system determined at 808 exceeds the threshold power level determined at step 806, the process proceeds to step 814. This comparison may take place in the processing circuitry, which may be substantially similar to the processing circuitry 324 of FIG. 3 or the processing circuitry 524 of FIG. 5.

If it is determined at step 812 that the power supplied by the energy storage system determined at 810 exceeds the threshold power level determined at step 806, the process proceeds to step 814. At step 814, the output voltage of the power controller, which may be substantially similar to the power controller output 244 of FIG. 2 or the power controller output 344 of FIG. 3, may be decreased. This may be performed by the power conversion circuitry, which may be substantially similar to the power conversion circuitry 340 of FIG. 3, the power controller 220 of FIG. 2, or the power controller 620 of FIG. 6. For example, the output voltage of the power controller may be decreased from a first voltage to a second voltage by changing the switching frequency of switches in a power controller, such as the switches 636 and 638 of the power controller 620 of FIG. 6. The change in power controller output may be controlled by processing circuitry outputs communicated through communication lines to the power controller or power conversion circuitry, which may be substantially similar to the communication lines 346 of FIG. 3, the power controller communication line 530 of FIG. 5, or the communication lines 630 and 631 of FIG. 6. The second voltage may be determined by algorithms or functions stored in the memory or processing circuitry, which may take inputs similar to those as determined at step 804.

At step 816, the output voltage of the generator, which may be substantially similar to the generator 102, is increased. This may be done through communication lines between the processing circuitry and the generator, such as the communication line 526 of FIG. 5 or the communication outputs 352 of FIG. 3. For example, the generator out voltage may be increased from a first generator power level to a second generator power level. The second generator power level may be calculated by algorithms or functions stored in the memory or processing circuitry, which may take inputs similar to those determined at step 804.

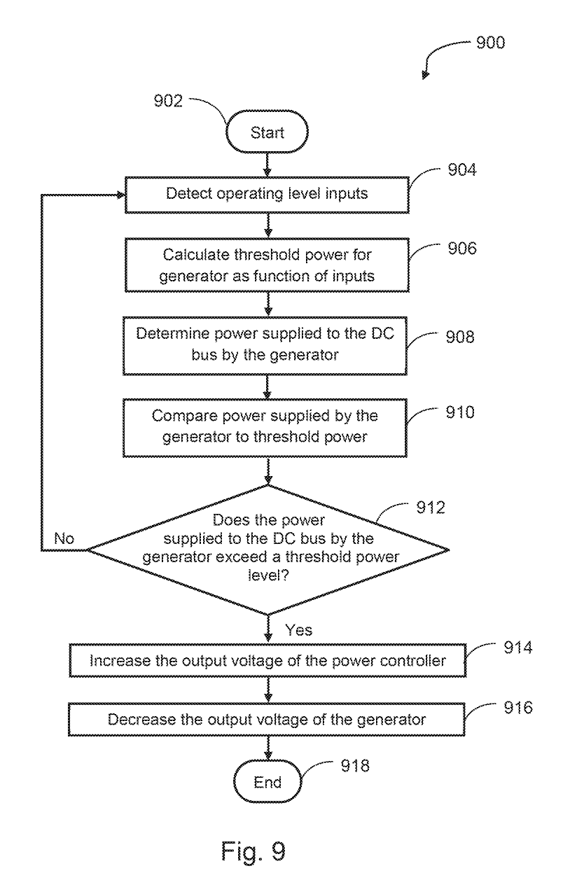

FIG. 9 shows an illustrative process 900 for delivering power, according to some embodiments, in a hybrid power delivery system, such as those shown in FIGS. 1, 2, and 4-6. The process 900 includes detecting operating level inputs at 904, calculating a threshold power level of a generator as a function of the inputs at 906, determining how much power is supplied to a DC bus by the generator at 908, comparing power supplied by the energy storage system to the calculated threshold power level at 910, upon determining that the power supplied to the DC bus by the generator exceeds the calculated threshold power level at 912, increasing the output voltage of a power controller at 914, and decreasing the output voltage of a generator at 916. In some embodiments, the process 900 may ensure that enough power is being supplied to the system, or that the generator is not operating at dangerously high levels. In some embodiments, the process 900 may be used by a hybrid power delivery system in an automobile, and may be used to determine when power is needed in the system, for example, when driving up steep grades or when towing large loads. The process 900 may ensure a safer driving experience, as the battery may contribute power to the system when the generator is running at high levels and may be in danger of overheating, and thus may ensure necessary power is supplied to an electric motor while driving.

Step 904 may be substantially similar to step 804 of FIG. 8. At step 906, a threshold power level for a generator, which may be substantially similar to the generator 102 of FIG. 1, may be calculated as a function of the inputs determined at step 904. While separate and distinct algorithms or functions may be used to calculate the threshold power level for the generator, the process may be substantially similar to that at step 806 in FIG. 8.

At step 908, a power supplied to a DC bus, which may be substantially similar to the DC bus 210 of FIG. 2, by the generator may be determined by, for example, the processing circuitry 524 of FIG. 5 or the communication interface 348 of FIG. 3. Illustrative examples of hybrid power delivery systems, FIGS. 1, 2, and 4-6, were presented, however, other configurations of the system may be contemplated. For example, step 908 may include determining the power supplied to the DC bus by one or more energy storage systems, or may include determining power supplied to one of more DC buses of one or more variable frequency drives, which may be substantially similar to the variable frequency drive 106 of FIG. 1.

At step 910, the threshold power level determined at step 906 may be compared to the power supplied by the generator as determined at step 908. At step 912, if it is determined that the power supplied by the generator determined at step 908 is less than or equal to the threshold power level, than the process may begin again, after some time period, at step 904, and process 900 may then be repeated. However, at step 912, if it is determined that the power supplied by the generator determined at 908 exceeds the threshold power level determined at step 906, the process proceeds to step 914. This comparison may take place by the processing circuitry, which may be substantially similar to the processing circuitry 324 of FIG. 3 or the processing circuitry 524 of FIG. 5.

At step 914, the output voltage of the power controller, which may be substantially similar to the power controller output 244 of FIG. 2 or the power controller output 344 of FIG. 3, may be increased. This may be performed by the power conversion circuitry, which may be substantially similar to the power conversion circuitry 340 of FIG. 3, the power controller 220 of FIG. 2, or the power controller 620 of FIG. 6. For example, the output voltage of the power controller may be increased from a first voltage to a second voltage by changing the switching frequency of switches in a power controller, such as the switches 636 and 638 of the power controller 620 of FIG. 6. The change in power controller output may be controlled by processing circuitry outputs communicated through communication lines to the power controller or power conversion circuitry, which may be substantially similar to the communication lines 346 of FIG. 3, the power controller communication line 530 of FIG. 5, or the communication lines 630 and 631 of FIG. 6. The second voltage may be determined by algorithms or functions, which may be substantially similar or different from those at step 814 in FIG. 8, stored in the memory or processing circuitry, which may take inputs similar to those as determined at step 904.

At step 916, the output voltage of the generator is increased. This may be done through communication lines between the processing circuitry and the generator, such as the communication line 526 of FIG. 5 or the communication outputs 352 of FIG. 3. For example, the generator out voltage may be increased from a first generator power level to a second generator power level. The second generator power level may be calculated by algorithms or functions stored in the memory or processing circuitry, which may take inputs similar to those determined at step 904.

The aforementioned processes 800 and 900 may ensure long term energy storage system health, prevent inefficiencies in the hybrid power delivery system, and may ensure necessary power is supplied to the output device, which may be a motor, as discussed above, or any other device or system that uses electric power. While the processes 800 and 900 both show a start and end of their respective processes, these processes may repeat upon their completion. Additional steps may be added to the processes 800 and 900, for example, to ensure long term energy storage system life and mitigate inefficiencies in the hybrid power delivery system. In some embodiments, the process 900 may have an additional step at which the energy storage system's state of charge, as determined at step 904, may be compared to a second threshold limit, calculated as a function of the inputs as detected at step 904. If the energy storage system's state of charge is above the second threshold limit, then the output of the power voltage of the power controller may be decreased from a third voltage to a fourth voltage, wherein the fourth voltage may be zero. Additional steps in the processes 800 and 900 may include, for example, additional algorithms or functions, additional input determinations, and additional system controls and outputs.

The foregoing is merely illustrative of the principles of the disclosure, and the systems, devices, and methods can be practiced by other than the described embodiments, which are presented for purposes of illustration and not of limitation.

Although the embodiments and features described herein are specifically described for use in connection with hybrid power delivery systems, it will be understood that the systems, devices, and methods described herein can be adapted and modified for any suitable power delivery application and that such other additions and modifications will not depart from the scope hereof. Variations and modifications will occur to those of skill in the art after reviewing this disclosure. The disclosed features may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented.

Examples of changes, substitutions, and alterations are ascertainable by one skilled in the art and could be made without departing from the scope of the information disclosed herein. All references are herein all incorporated by reference in their entirety and made part of this application.

What is claimed is:

1. A hybrid power delivery system comprising:
a generator configured to generate a first AC power;
a variable frequency drive coupled to the generator, the variable frequency drive comprising:
a first power converter coupled to the generator configured to convert the first AC power from the generator to DC power at a DC voltage;
a DC bus at the DC voltage coupled to the first power converter; and
a second power converter coupled to the DC bus configured to convert DC power at the DC voltage to a second AC power;
an energy storage system; and
a power controller coupled to the energy storage system and coupled to the DC bus, wherein the power controller is configured to regulate power flow between the energy storage system and the DC bus.

2. The hybrid power delivery system of claim 1 wherein the power controller comprises at least one of: a switch, a chopper circuit, a contactor, a silicon controlled rectifier, and a DC-to-DC converter.

3. The hybrid power delivery system of claim 1 further comprising a diode electrically coupled between the energy storage system and the DC bus.

4. The hybrid power delivery system of claim 3 wherein the diode is coupled in parallel with the power controller.

5. The hybrid power delivery system of claim 3 wherein the diode is configured to allow power to flow to the energy storage system.

6. The hybrid power delivery system of claim 1 wherein the energy storage system is at least one of a battery or a capacitor.

7. The hybrid power delivery system of claim 1 wherein the first AC power and the second AC power have a common amplitude.

8. The hybrid power delivery system of claim 1 wherein the first AC power has a different amplitude than the second AC power.

9. The hybrid power delivery system of claim 1 wherein the first AC power and the second AC power have a common frequency.

10. The hybrid power delivery system of claim 1 further comprising processing circuitry configured to receive inputs from at least one of: the generator, the energy storage system, the power controller, and the DC bus.

11. The hybrid power delivery system of claim 10 wherein the processing circuitry is configured to regulate the power delivered by the energy storage system by adjusting a voltage on an output of the power controller.

12. The hybrid power delivery system of claim 1 wherein an output voltage of the power controller is determined by a first switching frequency on a first switch, and a second switching frequency on a second switch.

13. A method of delivering power, the method comprising:
detecting, using processing circuitry, power supplied to a DC bus by an energy storage system, a power controller coupled between the DC bus and the energy storage system;
determining that power supplied to the DC bus by the energy storage system exceeds a threshold power level; and
in response to determining that the power supplied to the DC bus by the energy storage system exceeds the threshold power level, reducing an output voltage of the power controller from a first voltage level to a second voltage level.

14. The method of claim 13, further comprising:
in response to determining that the power supplied to the DC bus by the energy storage system exceeds the threshold power level, increasing an output power of a generator electrically coupled to the DC bus from a first generator power level to a second generator power level.

15. The method of claim 13, further comprising:
detecting, using processing circuitry, operating level inputs from at least one of: the generator, the DC bus, the power controller, and the energy storage system; and
determining the threshold power level using a function of the operating level inputs.

16. The method of claim 15 wherein the operating level inputs from the energy storage system comprise at least one of: a state of charge of the energy storage system, a state of health of the energy storage system, and a temperature of the energy storage system.

17. The method of claim 15 wherein the operating level inputs from the generator comprise at least one of: a voltage of the generator and a frequency of the generator.

18. The method of claim 13 wherein the power controller comprises at least one of: a switch, a chopper circuit, a contactor, a silicon controlled rectifier, and a DC-to-DC converter.

19. The method of claim 1 wherein the energy storage system is at least one of a battery or a capacitor.

20. A method of delivering power, the method comprising:
detecting, using processing circuitry, power supplied to a DC bus by an energy storage system, a power controller coupled between the DC bus and the energy storage system;
detecting, using the processing circuitry, power supplied to the DC bus by a generator;
determining that power supplied to the DC bus by the generator exceeds a threshold power level; and
in response to determining that the power supplied to the DC bus by the generator exceeds the threshold power level, increasing an output voltage of the power controller from a first voltage level to a second voltage level.

21. The method of claim 20, further comprising:
in response to determining that the power supplied to the DC bus by the generator exceeds the threshold power level, decreasing an output power of the generator from a first generator power level to a second generator power level.

22. The method of claim 20, further comprising:
detecting, using processing circuitry, operating level inputs from at least one of: the generator, the DC bus, the energy storage system, and the power controller; and
determining the threshold power level using a function of the operating level inputs.

23. The method of claim 22 wherein the operating level inputs from the energy storage system comprise at least one of: a state of charge of the energy storage system, a state of health of the energy storage system, and a temperature of the energy storage system.

24. The method of claim 23 further comprising:
determining that the state of charge of the energy storage system is less than a second threshold level; and
in response to determining that the state of charge of the energy storage system is less than the second threshold level, reducing the output voltage of the power controller from a third voltage to a fourth voltage.

25. The method of claim 22 wherein the operating level inputs from the generator comprise at least one of: a voltage of the generator and a frequency of the generator.

26. The method of claim 20 wherein the power controller comprises at least one of: a switch, a chopper circuit, a contactor, a silicon controlled rectifier, and a DC-to-DC converter.

27. The method of claim 20 wherein the energy storage system is at least one of a battery or a capacitor.
